(19) United States
(12) Patent Application Publication
(10) Pub. No.: US 2018/0020043 A1
(43) Pub. Date: Jan. 18, 2018

(54) METHOD FOR PLAYING AUDIO/VIDEO AND DISPLAY DEVICE

(71) Applicants: HISENSE ELECTRIC CO., LTD., QINGDAO (CN); HISENSE USA CORPORATION, SUWANEE, GA (US); HISENSE INTERNATIONAL CO., LTD., QINGDAO (CN)

(72) Inventors: YONGBANG WEI, QINGDAO (CN); SHIMING LU, QINGDAO (CN)

(21) Appl. No.: 15/394,701

(22) Filed: Dec. 29, 2016

(30) Foreign Application Priority Data
Jul. 13, 2016 (CN) 201610554127.7
Jul. 13, 2016 (CN) 201610554605.4

(51) Int. Cl. H04L 29/08; G06F 17/30; G06F 17/27; H04N 21/262; H04L 29/06

(52) U.S. Cl. CPC H04L 67/06; H04N 21/26258; H04L 67/02; H04L 65/60; G06F 17/2705; G06F 17/30076; G06F 17/30053; G06F 17/30091

(57) ABSTRACT

The present disclosure provides a method for playing an audio/video and a display device. The method for playing the audio/video of the present disclosure includes: downloading an audio/video clip in an audio/video to be played when a preceding-playing-page corresponding to the audio/video to be played is opened; the preceding-playing-page is any one page located before a playing page corresponding to the audio/video to be played; and playing the audio/video clip when the playing page is opened. The present disclosure can obtain the audio/video clip in the audio/video to be played through the connection to the network without on the playing page, thereby saving the playing start time, possessing a fast playing start speed and a short playing start time, and enhancing the user's experience.

### CROSS-REFERENCE TO RELATED APPLICATION

The present disclosure claims priority to Chinese Patent Application No. 201610554605.4, filed with SIPO on Jul. 13, 2016, entitled “Method for playing an Audio/Video and Display Device”, and Chinese Patent Application No. 201610554127.7, filed on Jul. 13, 2016, entitled “Method for playing an Audio/Video and Display Device”, which are hereby incorporated by reference in their entireties.

### FIELD OF THE TECHNOLOGY

The present disclosure relates to the field of audio/video playing technology, and in particular to a method for playing an audio/video and a display device.

### BACKGROUND

With the rapid development of network technology and the growing popularity of broadband fiber to the home, the networking and intellectualization of a variety of electronic devices and handheld devices make more and more users watch their favorite audio/video programs via the Internet.

During the playing of audio/video, a quick playing start can greatly enhance the satisfaction of users. At present, taking the Android Platform as an example, the playing start method of audio/video basically follows a common process, which specifically comprises the following steps: when the playing page is opened, the detection preparation before the playing start is carried out, such as downloading the audio/video data, parsing the audio/video data to obtain encoded mode and so on. Under the influence of network bandwidth and server performance, the downloading and parsing of audio/video data during the playing start process of audio/video are very time-consuming, thus, it will take a long time to play the audio/video after the program request.

### SUMMARY

The present disclosure provides a method for playing an audio/video and a display device.

One aspect of the present disclosure provides a method for playing an audio/video, including:

downloading an audio/video clip in an audio/video to be played when a preceding-playing-page corresponding to the audio/video to be played is opened; the preceding-playing-page is any one page located before a playing page corresponding to the audio/video to be played; and

playing the audio/video clip when the playing page is opened.

Another aspect of the present disclosure provides a display device, including:

a memory, configured to store instructions; a processor coupled to the memory and configured to execute the instructions stored in the memory, and the processor is configured to:

download an audio/video clip in an audio/video to be played when a preceding-playing-page corresponding to the audio/video to be played is opened; the preceding-playing-page is any one page located before a playing page corresponding to the audio/video to be played; and

play the audio/video clip when the playing page is opened.

### BRIEF DESCRIPTION OF THE DRAWINGS

In order to more clearly illustrate the technical solutions of embodiments of the present disclosure or the related art, the drawings which are required to be used in the description of the embodiments or the related art will be briefly described below, and it is obvious that the following drawings are some embodiments of the present disclosure. For those of ordinary skill in the art, other drawings can be obtained in accordance with these drawings without the creative effort.

FIG. 1 is a schematic view of a playing start process in the related art;

FIG. 2 is a flowchart of a method for playing an audio/video provided in some embodiments of the present disclosure;

FIG. 3A is a flow diagram of a method for playing an audio/video provided in some embodiments of the present disclosure;

FIG. 3B is a view of a playing start process of an embodiment provided by some embodiments of the present disclosure;

FIG. 4A is a flowchart of a method for playing an audio/video provided in some embodiments of the present disclosure;

FIG. 4B is a view of a playing start process of an embodiment provided by some embodiments of the present disclosure;

FIG. 5A is a structural view of a display device provided in some embodiments of the present disclosure;

FIG.5B is a structural view of a display device provided in some embodiments of the present disclosure;

FIG. 6A is a structural view of a display device provided in some embodiments of the present disclosure;

FIG. 6B is a structural view of a display device provided in some embodiments of the present disclosure; and

FIG. 7 is a structural view of a display device provided in some embodiments of the present disclosure.

### DETAILED DESCRIPTION

In order to make objectives, technical solutions and advantages of the embodiments of the present disclosure clearer, technical solutions in the embodiments of the present disclosure will be clearly and completely described hereunder with reference to the accompanying drawings in the embodiments of the present disclosure. Obviously, the described embodiment is only a part of embodiments of the present disclosure, rather than all embodiments of the present disclosure. Based on the embodiments of the present disclosure, all the other embodiments obtained by a person of ordinary skill in the art without making creative works are within the protection scope of the present disclosure.

The multimedia framework of the Android system in the related art provides a full set of standardized development process to the upper application. In this framework, a calling sequence of a player is specified by Android. In other words, the player-type applications perform only in accordance with the specified sequence to complete a playing start process of the audio/video.

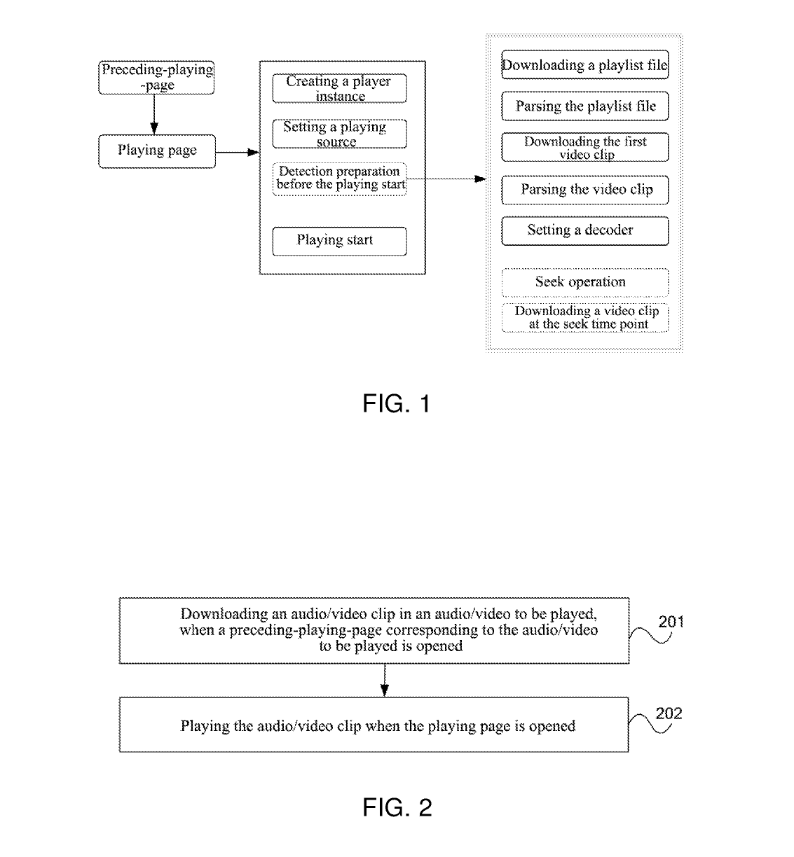

FIG.1 is a schematic view of a playing start process in the related art. In the playing start process of the related art, it is common to centralize the playing-related operations on the “playing page” for processing. FIG.1 shows a conventional playing start operation. Taking a video playing as an example, as shown in FIG.1, when the “playing page” is enabled, it will go through three steps successively, i.e., “creating a player instance”, “setting a playing source” and “detection preparation before the playing start”. In the step of “detection preparation before the playing start”, a number of operations, such as “downloading a playlist file”, “parsing the playlist file”, “downloading a first video clip”, “parsing the first video clip”, “setting a decoder” and so on, will be successively performed. According to the actual business requirements, the operations, such as seek operation, downloading the video data at the seek time point, and so on, may be included in the step of “the detection preparation before the playing start”. The seek operation refers to beginning to play from the last recorded playing position, and the downloading the video data at the seek time point thereof refers to downloading the video data at the last recorded playing position. Since the implementation of the above-mentioned steps needs a certain amount of execution time, especially for some networking operations, the playing start of the audio/video takes a long time.

The method in embodiments of the present disclosure aims at solving the problem that the playing start of the audio/video takes a long time, by optimizing the playing start process.

Terminals involved in embodiments of the present disclosure include, but are not limited to, intelligent terminal devices such as smart TVs, smart phones, and the like.

FIG. 2 is a flowchart of a method for playing an audio/video provided in some embodiments of the present disclosure. The method as shown in FIG. 2 includes:

step 201: downloading an audio/video clip in an audio/video to be played, when a preceding-playing-page corresponding to the audio/video to be played is opened;

the preceding-playing-page is any one page located before a playing page corresponding to the audio/video to be played.

The audio/video includes an audio, or includes a video. The audio/video to be played in some embodiments refers to the audio/video that a user wishes to play. The preceding-playing-page in some embodiments may be, for example, a “playlist page corresponding to the audio/video to be played”, “a playing detail page corresponding to the audio/video to be played”, or the like. Exemplarily, the preceding-playing-page is provided with a control, which is configured to open the playing page after receiving an operation from the user on the control. In some embodiments, the audio/video to be played includes a plurality of consecutive audio/video clips.

For instance, the user can select an audio or a video to be played through a display screen on the terminal. For example, the user clicks on a Letv video client installed on the terminal to display a directory browsing interface on the terminal. If the user wants to watch a movie therein, he/she can click on that movie on the directory browsing interface by using the display screen of the terminal, at this time, that movie is the video to be played. In general, a “playing detail page” (i.e., preceding-playing-page), for example, a page with a plot introduction of the movie, is opened before the movie's playing page is opened. Similarly, the user can select an audio to be played, such as a music, through the display screen on the terminal, and a “playing detail page” (i.e., preceding-playing-page), for example, a page with a title and singer introduction of the music, is opened before the audio's playing page is opened.

In general, before the audio or the video is played, such as before the playing page is opened, the preceding-playing-page is opened, and the user usually stays in the preceding-playing-page for a period of time and see the details of the audio or the video. Therefore, in the embodiment of the present disclosure, the terminal can perform some downloading operations when the preceding-playing-page corresponding to the audio or the video to be played is opened. For example, the downloading operation is downloading the audio clip in the audio to be played, so that this audio clip may be directly obtained when playing. The downloaded audio clip may include: the first N audio clips in the audio to be played, and the audio clip at the last recorded playing position, wherein N is an integer greater than zero Similarly, when the preceding-playing-page corresponding to the video to be played is opened, the terminal can the first N video clips in the video to be played, and the video clip at the last recorded playing position, wherein N is an integer greater than zero. Due to the influence of the network bandwidth, it is relatively time-consuming to download the audio/video clip by accessing the network. Therefore, by performing the downloading operation on the “preceding-playing-page” instead of on the “playing page”, a part of execution time required on the “playing page” can be undertook, thereby shortening the playing start time.

As an implementable way, the terminal can download the audio/video clip in the audio/video to be played through a HyperText Transfer Protocol (HTTP) proxy module.

step 202: playing the audio/video clip when the playing page is opened.

After the user enables the “playing page” on the terminal, the downloaded audio/video clip in the audio/video to be played can be directly played on the playing page of the terminal.

In the embodiment of the present disclosure, since the performance of the operation of downloading the audio/video clip in the audio/video to be played is advanced to the preceding-playing-page, it is not necessary to perform the operation of downloading the audio/video clip in the audio/video to be played on the playing page, only to perform the operation of playing the audio/video clip which has been stored locally when the playing page is opened, thereby shortening the playing start time and realizing a user experience of fast playing start.

The method in the embodiment of the present disclosure can be implemented based on the HTTP Live Streaming (HLS) protocol, in which the audio/video may be a file in a format of Transport Stream (TS), and the audio/video clip is a TS clip. The audio/video also may be a file in a format of WMA, and the audio/video clip is a WMA clip. Of course, the method of the embodiment of the present disclosure is applicable to the other HTTP protocols besides the HTTP Live Streaming (HLS) protocol.

In the method for playing the audio/video provided in the embodiment of the present disclosure, the audio/video clip in the audio/video to be played is downloaded when the preceding-playing-page corresponding to the audio/video to be played is opened, so that the downloaded audio/video clip can be played when the playing page corresponding to the audio/video to be played is opened. Since the operation of downloading the audio/video clip in the audio/video to be played is performed before the playing page is opened, the audio/video clip may be directly played when the playing page is opened, that is, the audio/video to be played is played. Compared with the related art, there is no need to connect to the network to download the audio/video clips in the audio/video to be played just when the playing page is opened, thereby saving the playing start time, realizing a fast playing start speed and a short playing start time, and increasing the user satisfaction.

In some embodiments of the present disclosure, an implementation for downloading the audio/video clip in the audio/video to be played is provided, that is, the above-described step 201 may be implemented as follows:

downloading the playlist file corresponding to the audio/video to be played when the preceding-playing-page is opened;

parsing the playlist file to obtain a file address of the audio/video clip in the audio/video to be played;

downloading the audio/video clip in the audio/video to be played according to the file address.

In some embodiments, in order to download the audio/video clip in the audio/video to be played, firstly, the terminal needs to download the playlist file corresponding to audio/video to be played, wherein the playlist file includes the file address of the audio/video clip. Therefore, when downloading the audio/video clip, the terminal can obtain the file address of the audio/video clip by parsing the playlist file, and further perform the downloading of the audio/video clip according to the obtained file address.

The above operations are also implemented on the preceding-playing-page.

As an implementable way, the remaining audio/video clips of the audio/video to be played can be downloaded in accordance with the file address obtained by parsing the playlist file.

For example, when the terminal downloads the playlist file from the network through the HTTP proxy module, the address to be accessed is: http://v.com/playlist.m3u8. The file address of the audio/video clip is as follows: http://v.com/00001.ts, http://v.com/00002.ts, and so on.

Herein, the above-described playlist file may be an M3U8 file when the embodiment of the present disclosure is implemented based on the HLS protocol. The M3U8 file refers to an M3U file in a UTF-8 encoding format, i.e., an MP3 URL (Moving Picture Experts Group Audio Layer III Uniform Resource Locator) file.

In the embodiment of the present disclosure, if the implementation is based on other HTTP protocols, no playlist file is needed to be obtained, and it only needs to obtain the file address of the audio/video to be played.

Furthermore, in order to enable the terminal to obtain the downloaded audio/video clip when the playing page is opened, in some embodiments of the present disclosure, an implementation is provided, and after downloading the audio/video clip according to the file address, the terminal can perform the following steps:

Storing the audio/video clip in a local database;

Converting the file address of the audio/video clip in the playlist file into a file address of the audio/video clip in the local database to obtain a converted playlist file;

Storing the converted playlist file in the local database.

Exemplarily, in order to enable the terminal to obtain the downloaded audio/video clip from the local database when the playing page corresponding to the audio/video to be played is opened, the terminal may store the audio/video clip in the local database after downloading the audio/video clip, and convert the file address of the audio/video clip in the playlist file into the file address of the audio/video clip in the local database. This operation is implemented on the preceding-playing-page.

In this way, when opening the playing page, the terminal may first read the converted playlist file from the local database and then parse the playlist file to obtain the file address of the audio/video clip in the local database. After that, the audio/video clip is read according to the file address from the local database, parsed to obtain a decoding mode of the audio/video to be played, and then the audio/video clip may be decoded and played according to the decoding mode of audio/video to be played.

In the practical application, the terminal may obtain the coding mode of the audio/video to be played by parsing the audio/video clip and obtain the decoding mode corresponding to the coding mode according to the coding mode. The coding mode of the audio/video may be such as MPEG-4, H264, and the like, or may be WMA, and the like.

For example, when the terminal downloads a playlist file of a video via an HTTP proxy module, the accessed address is: http://v.com/playlist.m3u8, the file addresses of the video clips are as follows: http://v.com/00001.ts, http://v.com/00002.ts, and so on.

After the video clip is downloaded and stored into the local database, the addresses are converted into addresses in the local database: the address of playlist file is: http://127.0.0.1/playlist.m3u8, the addresses of video clips are as follows: http://127.0.0.1/00001.ts, http://127.0.0.1/00002.ts, and so on. Similarly, when the terminal downloads a playlist file of an audio via an HTTP proxy module, an address of the playlist file and addresses of audio clips are downloaded and stored, then these addresses are converted into addresses in the local database. After that, the audio clip is read according to the file address from the local database, parsed to obtain a decoding mode of the audio to be played, and then the audio clip may be decoded and played according to the decoding mode of the audio to be played.

As an implementable way, the remaining audio/video clips of the audio/video to be played can also be downloaded and stored in the local database through the HTTP proxy module, so that the terminal can obtain and play the audio/video clips according to the file address obtained by parsing the playlist file when the playing page is opened.

As an implementable way, after downloading the audio/video clip according to the file address, the above-mentioned terminal may directly parse the audio/video clip to obtain the decoding mode of the audio/video to be played when the preceding-playing-page is opened. In this way, when opening the playing page, the terminal may directly decode and play the audio/video clip according to the decoding mode of audio/video to be played. Through this way, a part of execution time required on the “playing page” can be undertook, thereby shortening the playing start time.

In the embodiment of the present disclosure, the operations of downloading and parsing the audio/video clip in the audio/video to be played are performed on the preceding-playing-page in advance, instead of on the playing page, thereby the playing start time is further shortened and a user experience of fast playing start is achieved.

In some embodiments of the present disclosure, an implementation mode of playing the audio/video to be played is provided, that is, step 202 may be implemented as follows:

According to the decoding mode of the audio/video to be played, the audio/video clip in the audio/video to be played is decoded and played.

If the audio/video to be played selected by the user is played from the beginning, the terminal may decode and play the audio/video clip in the downloaded audio/video to be played according to the decoding mode obtained via parsing.

When the audio/video to be played is playing, that is, after the playing page is opened, the terminal downloads the other remaining audio/video clips in the audio/video to be played while playing, and then decodes and plays.

As another implementable way, the downloaded audio/video clip in the audio/video to be played at step 201 is an audio/video clip in a preset playing position, then step 202 may be implemented as follows:

According to the decoding mode, the audio/video clip in the preset playing position is decoded and played.

In the practical application, the terminal may record the content of the audio/video which has been played by the user, for example, record the playing position of the audio/video, such as a playing position of 13′ 50″. When the user plays that audio/video next time, the terminal downloads audio/video data in the preset playing position on the preceding-playing-page, and then decodes and plays the audio/video data in the preset playing position on the playing page.

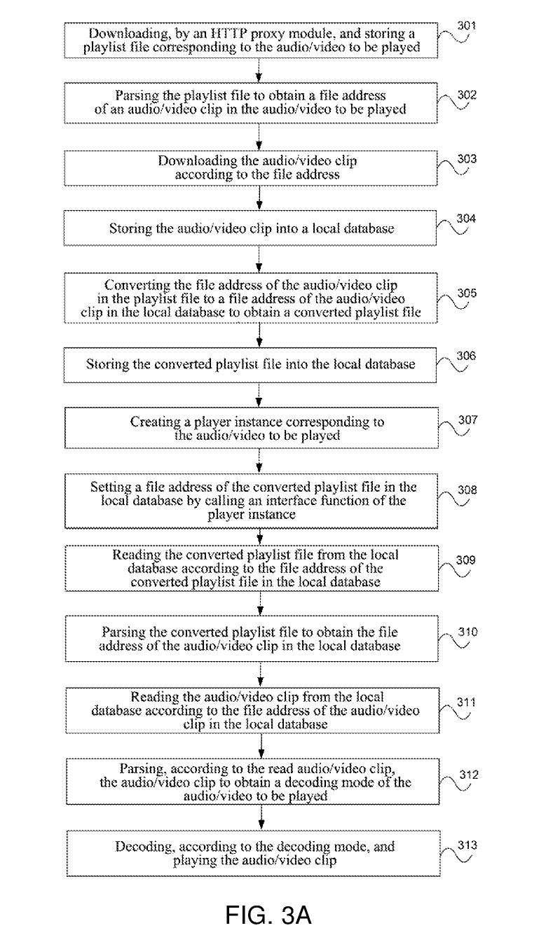

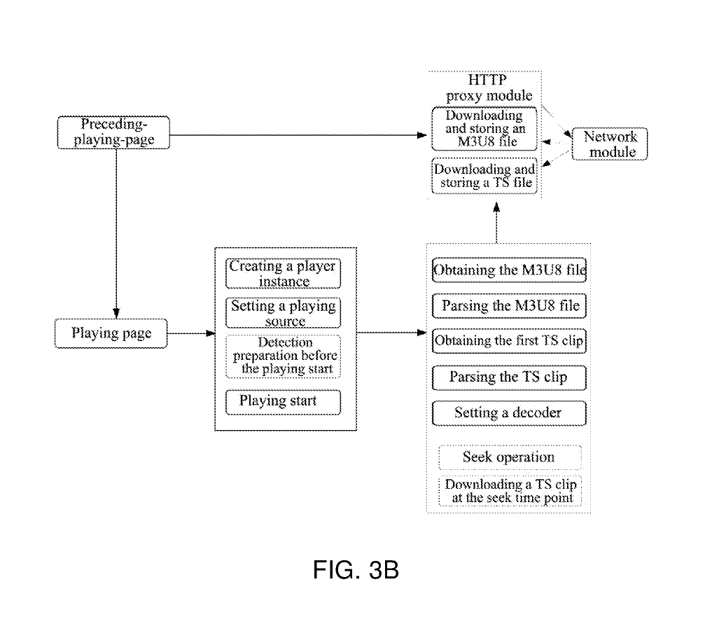

FIG. 3A is a flow diagram of a method for playing an audio/video provided in some embodiments of the present disclosure. As shown in FIG. 3A, it includes:

step 301: downloading, by an HTTP proxy module, and storing a playlist file corresponding to the audio/video to be played;

step 302: parsing the playlist file to obtain a file address of an audio/video clip in the audio/video to be played;

step 303: downloading the audio/video clip according to the file address;

step 304: storing the audio/video clip into a local database;

step 305: converting the file address of the audio/video clip in the playlist file to a file address of the audio/video clip in the local database to obtain a converted playlist file;

step 306: storing the converted playlist file into the local database;

step 307: creating a player instance corresponding to the audio/video to be played;

step 308: setting a file address of the converted playlist file in the local database by calling an interface function of the player instance;

step 309: reading the converted playlist file from the local database according to the file address of the converted playlist file in the local database;

step 310: parsing the converted playlist file to obtain the file address of the audio/video clip in the local database;

step 311: reading the audio/video clip from the local database according to the file address of the audio/video clip in the local database;

step 312: parsing, according to the read audio/video clip, the audio/video clip to obtain a decoding mode of the audio/video to be played;

step 313: decoding, according to the decoding mode, and playing the audio/video clip.

Step 301 to step 306 are performed on a preceding-playing-page, and other steps are performed on a playing page.

When opening the preceding-playing-page, the terminal first downloads through the HTTP proxy module and stores the playlist file corresponding to the audio/video to be played; obtains the audio/video clip in the audio/video to be played according to the file address of the audio/video clip in the playlist file, that is, parses the playlist file to obtain the file address of the audio/video clip; downloads the audio/video clip according to the file address, and stores the audio/video clip in the local database; and then converts the file address of the audio/video clip in the playlist file to the file address of the audio/video clip in the local database to obtain the converted playlist file, and then stores this converted playlist file into the local database. The foregoing embodiments are described in detail.

When opening the playing page, the terminal creates the player instance corresponding to the audio/video to be played; sets the file address of the converted playlist file in the local database by calling the interface function of the player instance.

For example, creating the player instance:

MediaPlayer mp=new MediaPlayer ( );

Setting the file address of the converted playlist file:

mp.setDataSource (“http://127.0.0.1/playlist.m3u8”).

Then, the converted playlist file is obtained from the local database according to the file address of the converted playlist file; the converted playlist file includes the file address of the audio/video clip in the local database.

When obtaining the audio/video clip, firstly, the converted playlist file is parsed to obtain the file address of the audio/video clip in the local database, and the audio/video clip can be read from the local database according to the obtained file address.

Then, according to the read audio/video clip, the decoding mode of the audio/video to be played is parsed;

Finally, the downloaded audio/video clip is decoded according to the decoding mode and played.

For example, when the playlist file is downloaded via the HTTP proxy module, the address to be accessed is: http://v.com/playlist.m3u8, then the playlist file is stored into the local database and the converted playlist file in the local database is obtained, the address in the local database converted from the address to be accessed is: http://127.0.0.1/playlist.m3u8.

As shown in FIG. 3B, in the method of the embodiment of the present disclosure implemented based on the HLS protocol, the terminal downloads on the preceding-playing-page an M3U8 file and a TS file from the network module through the HTTP proxy module and stores these two files.

When the playing page is opened, the player instance is created, that is, the player instance corresponding to the audio/video to be played is created. Then, the playing source is set, that is, the file address of the converted playlist file in the local database is set by calling the interface function of the player instance.

The detection preparation before the playing start is carried out, such as, obtaining the TS clip for parsing, to obtain the coding mode of the audio/video to be played, and setting the decoder, that is, setting the decoding mode corresponding to the coding mode. When playing, the decoding and playing may be carried out according to the decoding mode.

For example, the terminal may also perform a seek operation, that is, to start playing from a preset playing position, which requires to obtain a TS clip at seek time point in a preset playing position, namely, a TS fragment.

The implementation principle and technical effect of the technical solutions in the method of the present embodiment are similar to those in the method of the embodiments described above, and will not be repeated here.

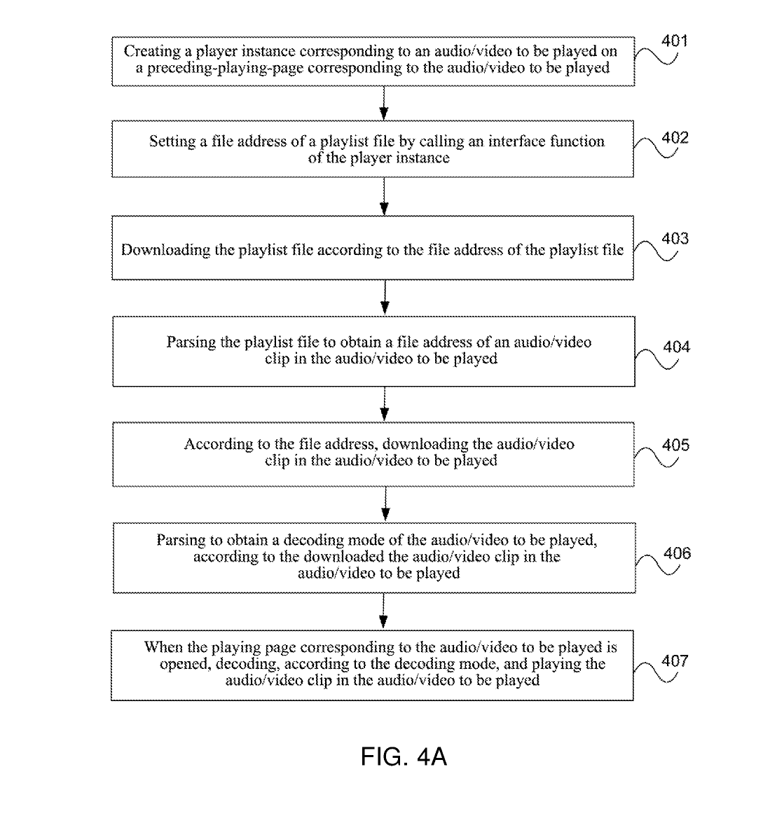

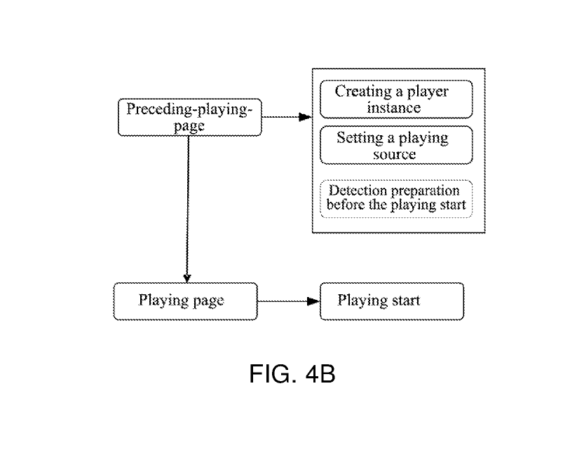

FIG. 4A is a flowchart of a method for playing an audio/video provided in some embodiments of the present disclosure. FIG. 4A is a view of a playing start process provided by some embodiments of the present disclosure. As shown in FIG. 4A, it includes:

step 401: creating a player instance corresponding to an audio/video to be played on a preceding-playing-page corresponding to the audio/video to be played;

step 402: setting a file address of a playlist file by calling an interface function of the player instance;

step 403: downloading the playlist file according to the file address of the playlist file;

step 404: parsing the playlist file to obtain a file address of an audio/video clip in the audio/video to be played;

step 405: according to the file address, downloading the audio/video clip in the audio/video to be played;

step 406: parsing to obtain a decoding mode of the audio/video to be played, according to the downloaded the audio/video clip in the audio/video to be played;

step 407: when the playing page corresponding to the audio/video to be played is opened, the audio/video clip in the audio/video to be played is decoded according to the decoding mode and played.

The method in the embodiment of the present disclosure can be realized on the basis of the HLS protocol. The terminal firstly creates a player instance corresponding to the audio/video to be played on the preceding-playing-page and sets the file address of the playlist file by calling the interface function of the player instance.

For example, creating the player instance:

MediaPlayer mp=new MediaPlayer ( );

Setting the file address of the playlist file:

mp.setDataSource (“aa”); aa can be, for example, a local address or a network address.

Then, the playlist file is downloaded according to the above-described file address of the playlist file; the playlist file includes the file address of the audio video clip.

When the audio/video clip is downloaded, firstly, the file address of the audio/video clip is obtained through parsing, and the downloading can be carried out according to the obtained file address;

Then, the decoding mode of the audio/video to be played is obtained by parsing according to the downloaded audio/video clip;

Finally, when the playing page corresponding to the audio/video to be played is opened, the audio/video to be played is played according to the decoding mode.

As an implementable way, playing the audio/video to be played means that the audio/video to be played is decoded and played.

As shown in FIG. 4B, when the preceding-playing-page is opened, the player instance is created, that is, the player instance corresponding to the audio/video to be played is created; the player source is set, that is, the file address of the playlist file is set by calling the interface function of the player instance; and the detection preparation before the playing start is performed. Steps are shown in FIG. 1.

On the playing page, the audio/video to be played is decoded and played according to the decoding mode corresponding to the coding mode obtained by parsing.

The implementation principle and technical effect of the technical solutions in the method of the present embodiment are similar to those in the method of the embodiments described above, and will not be repeated here.

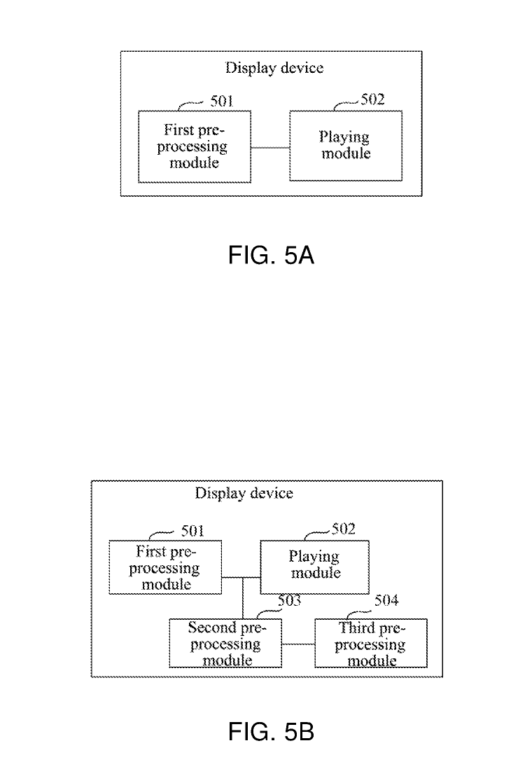

FIG. 5A is a structural view of a display device provided in some embodiments of the present disclosure. As shown in FIG. 5A, it includes:

a first pre-processing module 501 and a playing module 502,

Wherein the first pre-processing module 501 is configured to download data of an audio/video to be played when a preceding-playing-page corresponding to the audio/video to be played is opened and to parse the data of the audio/video to be played to obtain a decoding mode of the audio/video to be played. Wherein the preceding-playing-page is any one page located before a playing page corresponding to the audio/video to be played;

and a playing module 502 is configured to play the audio/video to be played according to the decoding mode when the playing page is opened.

FIG. 5B is a structural view of a display device provided in some embodiments of the present disclosure. As shown in FIG. 5B, as an implementable way, on the basis of the configuration shown in FIG. 5A, it further includes:

a second pre-processing module 503, configured to download a playlist file corresponding to the audio/video to be played,

The first pre-processing module 501 is configured to:

parse the playlist file to obtain a file address of the audio/video clip;

and download the audio/video clip according to the file address.

As an implementable way, the playing module 502 is configured to:

decoding the data of the audio/video to be played according to the decoding mode, and playing the audio/video data.

As an implementable way, the playing module 502 is further configured to:

obtain audio/video data in a preset playing position;

The playing module 502 is onfigured to:

decode the audio/video data in the preset playing position according to the decoding method and play the audio/video data.

As an implementable way, it may further include:

a third pre-processing module 504, configured to create a player instance corresponding to the audio/video to be played;

and set a file address of the playlist file by calling an interface function of the player instance;

The second pre-processing module 503 is configured to:

download the playlist file according to the file address of the playlist file.

The implementation principle and technical effect of the technical solutions in the apparatus of the present embodiment are similar to those in the method of the embodiments described above, and will not be repeated here.

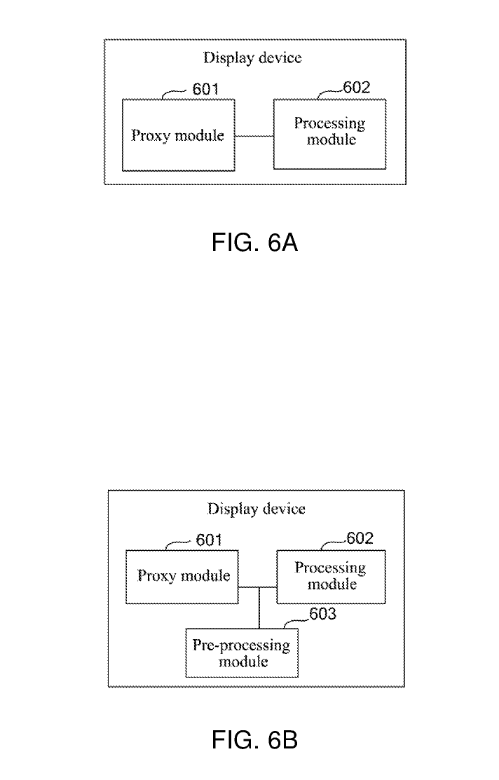

FIG. 6A is a structural view of a display device provided in some embodiments of the present disclosure. As shown in FIG. 6A, the display device includes:

a proxy module 601 and a processing module 602;

wherein the proxy module 601 is configured to download a audio/video clip in an audio/video to be played on a preceding-playing-page corresponding to the audio/video to be played, and the preceding-playing-page is any one page located before a playing page corresponding to the audio/video to be played;

the processing module 602 is configured to obtain the downloaded audio/video clip and parse the audio/video clip to obtain a decoding mode of the audio/video to be played when the playing page is opened;

the processing module 602 is further configured to decode the audio video to be played according to the decoding mode and play the audio video to be played.

As an implementable way, the proxy module 601 is configured to:

download the audio/video clip in the audio/video to be played through a hypertext transfer protocol (HTTP) proxy server.

As an implementable way, the proxy module 601 is further configured to:

download the playlist file corresponding to the audio/video to be played through the HTTP proxy server and store the playlist file.

The proxy module 601 is configured to:

parse the playlist file to obtain a file address of the audio/video clip;

and download the audio/video clip according to the file address.

As an implementable way, the proxy module 601 is further configured to:

convert the file address of the audio/video clip in the playlist file into the file address of the audio video clip in the HTTP proxy server.

The processing module 602 is configured to:

obtain the playlist file and parse the playlist file to obtain the file address of the audio/video clip;

and obtain the audio/video clip from the HTTP proxy server according to the file address.

As an implementable way, the processing module 602 is configured to:

decode the audio/video clip in the audio/video to be played according to the decoding mode, and playing the decoded audio/video clip.

As an implementable way, the processing module 602 is further configured to:

obtain an audio/video clip in a preset playing position.

The processing module 602 is configured to:

decode the audio/video clip in the preset playing position according to the decoding mode, and play the audio/video clip.

FIG. 6B is a structural view of a display device provided in some embodiments of the present disclosure. As shown in FIG. 6B, as an implementable way, on the basis of the configuration shown in FIG. 6A, the display device further includes:

a pre-processing module 603, configured to create a player instance corresponding to the audio/video to be played.

The pre-processing module 603 is further configured to set the file address of the playlist file in the HTTP proxy server by calling the interface function of the player instance.

The processing module 602 is configured to obtain the playlist file from the HTTP proxy server according to the file address of the playlist file.

The implementation principle and technical effect of the technical solutions in the apparatus of the present embodiment are similar to those in the method of the embodiments described above, and will not be repeated here.

The present disclosure also provides a display device, including: a memory for storing instructions; a processor coupled to the memory and configured to execute instructions stored in the memory, and the processor is configured to: download the audio/video clip in the audio/video to be played when the preceding-playing-page corresponding to the audio/video to be played is opened, wherein the preceding-playing-page is any one page located before the playing page corresponding to the audio/video to be played; and play the audio/video clip when the playing page is opened.

The processor in the display device of the embodiment of the present disclosure may also be configured to perform any one of the audio/video playing methods provided in the foregoing embodiments of the present disclosure, and the implementation principle of which is similar and will not be described herein.

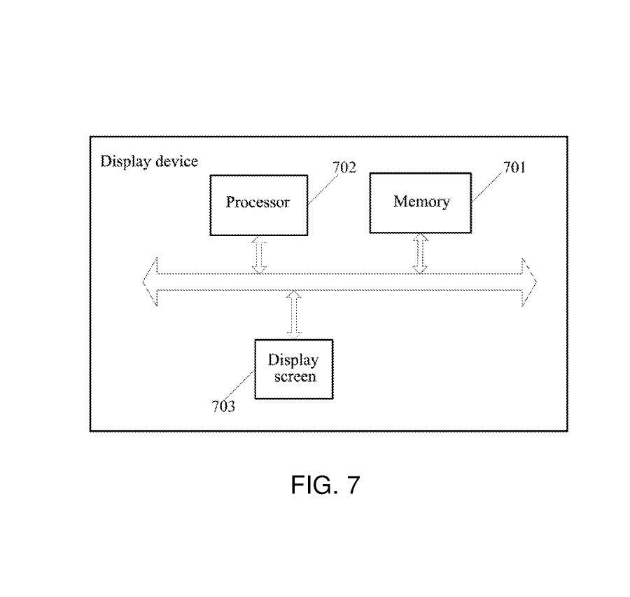

FIG. 7 is a structural view of a display device provided in some embodiments of the present disclosure. As shown in FIG. 7, the display device includes: a memory 701, a processor 702, and a display screen 703; wherein the memory 701 is configured to store a program; exemplarily, the program may include program code including computer operating instructions. The memory 701 may include random access memory (RAM), or may also include non-volatile memory, such as at least one disk memory.

A processor 702 for executing a program stored in the memory 701, is configured to execute the technical solution provided in the embodiment of the present disclosure with the implementation principle and technical effect similar to the above-described method of the embodiment, and will not be described herein.

A display screen 703 is configured to display the audio/video to be played.

The functions of the first pre-processing module, the second pre-processing module, the third pre-processing module and the playing module in the above-described apparatus may be implemented by the processor 702. The functions of the proxy module, the pre-processing module, and the processing module in the above-described apparatus may also be implemented by the processor 702.

One or more buses can be used for communication among the above-mentioned components. It will be understood by those skilled in the art that the structure of the terminal shown in FIG. 7 is not intended to limit to the present disclosure and may be of either a bus configuration or a star configuration. The structure may also include more or less components compared with the illustration, or combine a certain components, or have different component arrangements.

It should be noted that, for the display device embodiment, since it substantially corresponds to the method embodiment, its related portions can be referred to the partial explanations of the method embodiments.

It will be appreciated by those of ordinary skill in the art that all or parts of the steps of implementing the method embodiments described above may be accomplished by hardware related to the program instructions, which may be stored in a computer readable storage medium. When the program is executed, the steps of the above-described method embodiment are executed. The aforementioned storage medium includes various kinds of media for storing the program codes, such as a ROM, a RAM, a magnetic disk, or an optical disk.

Finally, it should be noted that the above embodiments are merely illustrative of the technical solutions of the present disclosure and are not to be construed as limitations thereof. While the present disclosure has been described in detail with reference to the foregoing embodiments, it will be understood by those skilled in the art that: the technical solutions described in the foregoing embodiments can be modified or equivalently replaced with some or all of the technical features, and these modifications and replacements will not make the essence of the technical solutions depart from the scope of the technical solutions of each embodiment in the present disclosure.

What is claimed is:

1. A method for playing an audio/video, comprising:
downloading an audio/video clip in an audio/video to be played when a preceding-playing-page corresponding to the audio/video to be played is opened; the preceding-playing-page is any one page located before a playing page corresponding to the audio/video to be played; and
playing the audio/video clip when the playing page is opened.

2. The method according to claim 1, wherein the preceding-playing-page is a playlist page corresponding to the audio/video to be played, or a playing detail page corresponding to the audio/video to be played.

3. The method according to claim 1, wherein the downloading the audio/video clip in the audio/video to be played when the preceding-playing-page corresponding to the audio/video to be played is opened, comprises:
downloading a playlist file corresponding to the audio/video to be played when the preceding-playing-page is opened;
parsing the playlist file to obtain a file address of the audio/video clip; and
downloading the audio/video clip according to the file address.

4. The method according to claim 3, after the downloading the audio/video clip according to the file address, further comprising:
storing the audio/video clip in a local database;
converting the file address of the audio/video clip in the playlist file to a file address of the audio/video clip in the local database, to obtain a converted playlist file; and
storing the converted playlist file in the local database.

5. The method according to claim 4, wherein the playing the audio/video clip when the playing page is opened, comprises:
reading the converted playlist file from the local database when the playing page is opened;
parsing the converted playlist file to obtain the file address of the audio/video clip in the local database;
reading the audio/video clip from the local database according to the file address of the audio/video clip in the local database;
parsing the audio/video clip to obtain a decoding mode of the audio/video to be played;
decoding, according to the decoding mode of the audio/video to be played, and playing the audio/video clip.

6. The method according to claim 5, before the reading the converted playlist file from the local database, further comprising:
creating a player instance corresponding to the audio/video to be played;
setting a file address of the converted playlist file in the local database by calling an interface function of the player instance;
the reading the converted playlist file from the local database comprises:
reading the converted playlist file from the local database according to the file address of the converted playlist file in the local database.

7. The method according to claim 3, before the playing the audio/video clip when the playing page is opened, comprising:
parsing the audio/video clip to obtain a decoding mode of the audio/video to be played;
the playing the audio/video clip when the playing page is opened, comprises:
decoding, according to the decoding mode of the audio/video to be played, and playing the audio/video clip when the playing page is opened.

8. The method according to claim 3, before the downloading the playlist file corresponding to the audio/video to be played, further comprising:
creating a player instance corresponding to the audio/video to be played;
setting a file address of the playlist file by calling an interface function of the player instance;
the downloading the playlist file corresponding to the audio/video to be played comprises:
downloading the playlist file according to the file address of the playlist file.

9. The method according to claim 1, the downloading the audio/video clip in the audio/video to be played, comprising:
downloading an audio/video clip in a preset playing position.

10. A display device, comprising: a memory, configured to store instructions; and a processor coupled to the memory, wherein the processor is configured to perform the instructions stored in the memory, and the processor is configured to:
download an audio/video clip in an audio/video to be played when a preceding-playing-page corresponding to the audio/video to be played is opened; the preceding-playing-page is any one page located before a playing page corresponding to the audio/video to be played; and
play the audio/video clip when the playing page is opened.

11. The display device according to claim 10, wherein the preceding-playing-page is a playlist page corresponding to the audio/video to be played, or, a playing detail page corresponding to the audio/video to be played.

12. The display device according to claim 10, wherein the processor is configured to:
download a playlist file corresponding to the audio/video to be played when the preceding-playing-page is opened;
parse the playlist file to obtain a file address of the audio/video clip; and
download the audio/video clip according to the file address.

13. The display device according to claim 12, wherein the processor is further configured to:
store the audio/video clip into a local database;
convert the file address of the audio/video clip in the playlist file into a file address of the audio/video clip in the local database, to obtain a converted playlist file; and
store the converted playlist file into the local database.

14. The display device according to claim 13, wherein the processor is configured to:
read the converted playlist file from the local database when the playing page is opened;
parse the converted playlist file to obtain the file address of the audio/video clip in the local database;
read the audio/video clip from the local database according to the file address of the audio/video clip in the local database;
parse the audio/video clip to obtain a decoding mode of the audio/video to be played; and
decode, according to the decoding mode of the audio/video to be played, and play the audio/video clip.

15. The display device according to claim 14, wherein the processor is configured to:
create a player instance corresponding to the audio/video to be played;
set a file address of the converted playlist file in the local database by calling an interface function of the player instance; and
read the converted playlist file from the local database according to the file address of the converted playlist file in the local database.

16. The display device according to claim 12, wherein the processor is configured to:
parse the audio/video clip to obtain a decoding mode of the audio/video to be played; and
decode, according to the decoding mode of the audio/video to be played, and play the audio/video clip when the playing page is opened.

17. The display device according to claim 12, wherein the processor is configured to:
create a player instance corresponding to the audio/video to be played;
set a file address of the playlist file by calling an interface function of the player instance;
download the playlist file according to the file address of the playlist file.

18. The display device according to claim 10, wherein the processor is configured to:
download an audio/video clip in a preset playing position.
